(19) United States
(12) Patent Application Publication
(10) Pub. No.: US 2020/0217942 A1
(43) Pub. Date: Jul. 9, 2020

(54) METHOD AND SYSTEM FOR DETECTING VEHICLE OCCUPANTS

(71) Applicant: GM GLOBAL TECHNOLOGY OPERATIONS LLC, Detroit, MI (US)

(72) Inventor: Ron Y. Asmar, West Bloomfield, MI (US)

(21) Appl. No.: 16/238,745

(22) Filed: Jan. 3, 2019

(51) Int. Cl. G01S 13/04; B60Q 5/00; B60Q 1/52; E05F 15/73; G01S 7/41

(52) U.S. Cl. CPC G01S 13/04; B60Q 5/005; E05Y 2900/55; E05F 15/73; G01S 7/411; B60Q 1/52

(57) ABSTRACT

One general aspect includes a method to detect occupants within a vehicle interior, the method including: calculating a current received signal strength indication (RSSI) within a vehicle interior; comparing the current RSSI to a reference RSSI; and based on comparing the current RSSI and reference RSSI, activating one or more vehicle systems.

### INTRODUCTION

The bodies of children and pets are primarily composed of salt water. As a result, they can absorb and distort nearby Bluetooth Low Energy (BLE) signals. Moreover, multiple BLE nodes can be installed and operated in a vehicle and when the Received Signal Strength Indication (RSSI) of the BLE signals is distorted, this distortion can be utilized to determine the presence of children and pets present in the vehicle's cabin. Furthermore, based on this technology, a system and method can be constructed to notify a vehicle operator when a child/pet is trapped in the cabin of their vehicle. This system and method can also be configured to activate one or more safety measures to ensure the child/pet is not harmed while the vehicle owner is being notified of these circumstances. That said, other desirable features and characteristics of the present invention will become apparent from the subsequent detailed description of the invention and the appended claims, taken in conjunction with the accompanying drawings and this background of the invention. One exemplary characteristic of this system and method is that utilizing RSSI does not require any motion to detect the presence of a trapped vehicle occupant. For example, this system and method would just as easily detect an infant fast asleep underneath a blanket as it would a finicky dog rapidly jumping around the vehicle interior.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to detect occupants within a vehicle interior, the method including: calculating a current received signal strength indication (RSSI) within a vehicle interior; comparing the current RSSI to a reference RSSI; and based on comparing the current RSSI and reference RSSI, activating one or more vehicle systems. Other embodiments of this aspect include corresponding computer systems, apparatus, and computer programs recorded on one or more computer storage devices, each configured to perform the actions of the methods.

Implementations may include one or more of the following features. The method further including: where comparing the current RSSI and reference RSSI is the difference between the current RSSI and the reference RSSI; determining whether the difference between the current RSSI and reference RSSI is greater than a threshold value; and where activating the one or more vehicle systems occurs only after the difference between the current RSSI and the reference RSSI is determined to be greater than the threshold value. The method where the difference between the current RSSI and the reference RSSI is determined a plurality of times until an expiration of a second time period or when the difference between the current RSSI and the reference RSSI is determined to be greater than a threshold value; and in response to air conditioning operations being turned to an ON state or one or more vehicle doors being opened or the expiration of the second time period, deactivating the one or more vehicle systems and/or the method will move to completion. The method further including: sensing a temperature within the vehicle interior as a vehicle temperature; determining whether the vehicle temperature is greater than a threshold temperature; and where calculating the current RSSI occurs only after the vehicle temperature is determined to be greater than a threshold temperature. The method where calculating the current RSSI occurs only after air conditioning operations are turned to an OFF state and all vehicle doors are closed. The method where the current RSSI includes calculating a plurality of RSSI measurements over a first-time period and calculating an average RSSI measurement from the plurality of RSSI measurements. The method where activating the one or more vehicle systems includes at least partially opening one or more vehicle windows. The method where activating the one or more vehicle systems includes activating a horn system and a light system in an ordered sequence. Implementations of the described techniques may include hardware, a method or process, or computer software on a computer-accessible medium.

One general aspect includes a system to detect occupants within a vehicle interior, the system including: a memory configured to include one or more executable instructions and a processor configured to execute the executable instructions, where the executable instructions enable the processor to: calculate a current received signal strength indication (RSSI) within a vehicle interior; compare the current RSSI to a reference RSSI; and based on the comparison of the current RSSI and reference RSSI, activate one or more vehicle systems. Other embodiments of this aspect include corresponding computer systems, apparatus, and computer programs recorded on one or more computer storage devices, each configured to perform the actions of the methods.

Implementations may include one or more of the following features. The system further including: where the comparison of the current RSSI and reference RSSI is the difference between the current RSSI and the reference RSSI; determine whether the difference between the current RSSI and reference RSSI is greater than a threshold value; and where the one or more vehicle systems occurs are activated after the difference between the current RSSI and the reference RSSI is determined to be greater than the threshold value. The system further including: where the difference between the current RSSI and the reference RSSI is determined a plurality of times until an expiration of a second-time period or when the difference between the current RSSI and the reference RSSI is determined to be greater than a threshold value; and in response to air conditioning operations being turned to an ON state or one or more vehicle doors being opened or the expiration of the second-time period, deactivate the one or more vehicle systems and/or the processor will cause the system to move to completion. The system further including: calculate a temperature within the vehicle interior as a vehicle temperature; determine whether the vehicle temperature is greater than a threshold temperature; and where the calculation of the current RSSI occurs only after the vehicle temperature is determined to be greater than a threshold temperature. The system where the calculation of the current RSSI occurs only after air conditioning operations are turned to an OFF state and all vehicle doors are closed. The system where the current RSSI includes a calculation of a plurality of RSSI measurements over a first-time period and a calculation of an average RSSI measurement from the plurality of RSSI measurements. The system where activation of the one or more vehicle systems includes at least partially opening one or more vehicle windows. The system where activation of the one or more vehicle systems includes activation of a horn system and a light system in an ordered sequence. Implementations of the described techniques may include hardware, a method or process, or computer software on a computer-accessible medium.

One general aspect includes a non-transitory and machine-readable medium having stored thereon executable instructions adapted to detect occupants within a vehicle interior, which when provided to a processor and executed thereby, causes the processor to: calculate a current received signal strength indication (RSSI) within a vehicle interior, air conditioning operations are turned to an OFF state and all vehicle doors are closed; compare the current RSSI to a reference RSSI; and based on the comparison of the current RSSI and reference RSSI, at least partially open one or more vehicle windows, or activate of a horn system and a light system in an ordered sequence, or send an emergency notification to a remote entity or mobile computing device, or some combination thereof. Other embodiments of this aspect include corresponding computer systems, apparatus, and computer programs recorded on one or more computer storage devices, each configured to perform the actions of the methods.

Implementations may include one or more of the following features. The non-transitory and machine-readable memory which further causes the processor to: where the comparison of the current RSSI and reference RSSI is the difference between the current RSSI and the reference RSSI; determine whether the difference between the current RSSI and reference RSSI is greater than a threshold value; and where the one or more vehicle systems occurs are activated after the difference between the current RSSI and the reference RSSI is determined to be greater than the threshold value. The non-transitory and machine-readable memory which further causes the processor to: calculate a temperature within the vehicle interior as a vehicle temperature; determine whether the vehicle temperature is greater than a threshold temperature; and where the calculation of the current RSSI occurs only after the vehicle temperature is determined to be greater than a threshold temperature. The non-transitory and machine-readable memory where the current RSSI includes a calculation of a plurality of RSSI measurements over a first-time period and a calculation of an average RSSI measurement from the plurality of RSSI measurements. Implementations of the described techniques may include hardware, a method or process, or computer software on a computer-accessible medium.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of system capable of utilizing the system and method disclosed herein;

FIG. 2 is a flowchart of an exemplary process for detecting a helpless occupant in a vehicle;

FIG. 3 depicts an application of an exemplary aspect of the process of FIG. 3 in accordance with one or more exemplary embodiments;

FIG. 4 depicts an exemplary aspect of the process of FIG. 3 in accordance with one or more exemplary embodiments; and

FIG. 5 is a flowchart of an exemplary aspect of the process of FIG. 2 in accordance with one or more exemplary embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

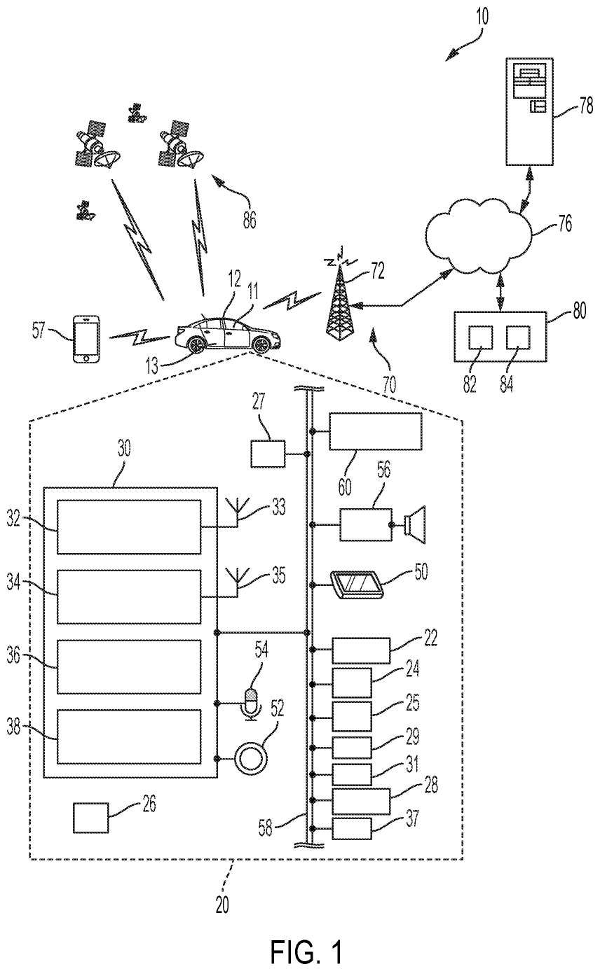

With reference to FIG. 1, there is shown an operating environment that comprises a communications system 10 and that can be used to implement the method disclosed herein. Communications system 10 generally includes a vehicle 12 that includes vehicle electronics 20, one or more wireless carrier systems 70, a land communications network 76, a computer or server 78, a vehicle backend services facility 80, and a constellation of global navigation satellite system (GNSS) satellites 86. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

Some of the vehicle electronics 20 are shown generally, in FIG. 1 and includes a global navigation satellite system (GNSS) receiver 22, a body control module or unit (BCM) 24, a Virtual Key Module (VKM) 25, other vehicle system modules (VSMs) 28, a telematics unit 30, vehicle-user interfaces 50-56, and onboard computer 60. Some or all of the different vehicle electronics may be connected for communication with each other via one or more communication busses, such as communications bus 58. The communications bus 58 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few. In other embodiments, a wireless communications network that uses short-range wireless communications (SRWC) to communicate with one or more VSMs of the vehicle can be used. In one embodiment, the vehicle 12 can use a combination of a hardwired communications bus 58 and SRWCs. The SRWCs can be carried out using the telematics unit 30, for example.

The vehicle 12 can include numerous vehicle system modules (VSMs) as part of vehicle electronics 20, such as the GNSS receiver 22, BCM 24, Virtual Key Module 25, telematics unit 30 (vehicle communications system), vehicle-user interfaces 50-56, and onboard computer 60, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is hardwire connected by communications bus 58 to the other VSMs including the telematics unit 30. Moreover, each of the VSMs can include and/or be communicatively coupled to suitable hardware that enables intra-vehicle communications to be carried out over the communications bus 58; such hardware can include, for example, bus interface connectors and/or modems. One or more VSMs 28 may periodically or occasionally have their software or firmware updated and, in some embodiments, such vehicle updates may be over the air (OTA) updates that are received from computer 78 or remote facility 80 via land network 76 and telematics unit 30. As is appreciated by those skilled in the art, the above-mentioned VSMs are only examples of some of the modules that may be used in vehicle 12, as numerous others are also possible. It should also be appreciated that these VSMs can otherwise be known as electronic control units, or ECUs.

Global navigation satellite system (GNSS) receiver 22 receives radio signals from a constellation of GNSS satellites 86. The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 86. And, in another example, GNSS receiver 22 can be a BDS receiver that receives a plurality of GNSS (or BDS) signals from a constellation of GNSS (or BDS) satellites 86. The GNSS received can determine a current vehicle location based on reception of a plurality of GNSS signals from the constellation of GNSS satellites 86. The vehicle location information can then be communicated to the telematics unit 30, or other VSMs, such as the onboard computer 60. In one embodiment (as shown in FIG. 1), the wireless communications module 30 and/or a telematics unit can be integrated with the GNSS receiver 22 so that, for example, the GNSS receiver 22 and the telematics unit 30 (or the wireless communications device) are directly connected to one another as opposed to being connected via communications bus 58. In other embodiments, the GNSS receiver 22 is a separate, standalone module or there may be a GNSS receiver 22 integrated into the telematics unit 30 in addition to a separate, standalone GNSS receiver connected to telematics unit 30 via communications bus 58.

Body control module (BCM) 24 can be used to control various VSMs 28 of the vehicle, as well as obtain information concerning the VSMs, including their present state or status, as well as sensor information. The BCM 24 is shown in the exemplary embodiment of FIG. 1 as being electrically coupled to the communication bus 58. In some embodiments, the BCM 24 may be integrated with or part of a center stack module (CSM) and/or integrated with telematics unit 30 or the onboard computer 60. Or, the BCM may be a separate device that is connected to other VSMs via bus 58. The BCM 24 can include a processor and/or memory, which can be similar to processor 36 and memory 38 of telematics unit 30, as discussed below. The BCM 24 may communicate with wireless device 30 and/or one or more vehicle system modules, such as an engine control module (ECM), audio system 56, or other VSMs 28; in some embodiments, the BCM 24 can communicate with these modules via the communications bus 58. Software stored in the memory and executable by the processor enables the BCM to direct one or more vehicle functions or operations including, for example, controlling central locking, power windows 11, power sun/moon roof, the vehicle's head lamps 98, the horn system 99, air conditioning operations, power mirrors, controlling the vehicle primary mover (e.g., engine, primary propulsion system), and/or controlling various other vehicle modules. In one embodiment, the BCM 24 can be used (at least in part) to detect a vehicle event, such as a power on state or a power off state or when the vehicle's air conditioning operations are turned ON or OFF (i.e., cooled air is being blown or is stopped being blown from the vents of the vehicle's Heating Ventilation and Air Conditioning (HVAC) system), based on one or more onboard vehicle sensor readings, as discussed more below.

The Virtual Key Module (VKM) 25 provides passive detection of the absence or presence of a virtual vehicle key. The VKM 25 can use authentication information received from remote facility 80 to determine if a mobile computing device 57 with a virtual vehicle key downloaded thereon is authorized/authentic to vehicle 12. If the virtual vehicle key is deemed authentic, the VKM 25 can send a command to BCM 24 permitting access to the vehicle 12. It should be understood that the VKM 25 may be an electronic hardware component connected to the vehicle bus 58 and can include a processor and/or memory, which can be similar to processor 36 and memory 38 of telematics unit 30, as discussed below. In an alternative embodiment, VKM 25 may be one or more software code segments uploaded to electronic memory 38.

Telematics unit 30 is capable of communicating data via SRWC through use of SRWC circuit 32 and/or via cellular network communications through use of a cellular chipset 34, as depicted in the illustrated embodiment. The telematics unit 30 can provide an interface between various VSMs of the vehicle 12 and one or more devices external to the vehicle 12, such as one or more networks or systems at remote facility 80. This enables the vehicle to communicate data or information with remote systems, such as remote facility 80.

In at least one embodiment, the telematics unit 30 can also function as a central vehicle computer that can be used to carry out various vehicle tasks. In such embodiments, the telematics unit 30 can be integrated with the onboard computer 60 such that the onboard computer 60 and the telematics unit 30 are a single module. Or, the telematics unit 30 can be a separate central computer for the vehicle 12 in addition to the onboard computer 60. Also, the wireless communications device can be incorporated with or a part of other VSMs, such as a center stack module (CSM), body control module (BCM) 24, an infotainment module, a head unit, a telematics unit, and/or a gateway module. In some embodiments, the telematics unit 30 is a standalone module, and can be implemented as an OEM-installed (embedded) or aftermarket device that is installed in the vehicle.

In the illustrated embodiment, telematics unit 30 includes, the SRWC circuit 32, the cellular chipset 34, a processor 36, memory 38, SRWC antenna 33, and antenna 35. The telematics unit 30 can be configured to communicate wirelessly according to one or more SRWC protocols such as any of the Wi-Fi™, WiMAX™, Wi-Fi™ Direct, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. And, in some embodiments, the telematics unit 30 can be configured to communicate using IEEE 802.11p such that the vehicle can carry out vehicle-to-vehicle (V2V) communications, or vehicle-to-infrastructure (V2I) communications with infrastructure systems or devices, such as the remote facility 80. And, in other embodiments, other protocols can be used for V2V or V2I communications.

The SRWC circuitry 32 enables the telematics unit 30 to transmit and receive SRWC signals, such as BLE signals. The SRWC circuit can allow the telematics unit 30 to connect to another SRWC device (e.g., mobile computing device 57). The SRWC circuit 32 can be in communication with one or more subset components, embodied as BLE nodes 26, that are installed at locations throughout vehicle 12. Each subset BLE node 26 incorporates a BLE radio sensor and is thus a transceiver that can transmit and receive SRWC serial data signals (via an SRWC protocol) to and from another subset BLE node 26, SRWC circuit 32, or any one of the VSMs 28 (including, but not limited to, BCM 24 and VKM 25). As follows, incorporating the BLE nodes 26 allows for Bluetooth mesh networking to occur within the interior cabin of vehicle 12. Additionally, in some embodiments, the telematics unit 30 contains a cellular chipset 34 thereby allowing the device to communicate via one or more cellular protocols, such as those used by cellular carrier system 70, through antenna 35. In such a case, the telematics unit 30 is user equipment (UE) that can be used to in carry out cellular communications via cellular carrier system 70.

Antenna 35 is used for communications and is generally known to be located throughout vehicle 12 at one or more locations external to the telematics unit 30. Using antenna 35, telematics unit 30 may enable the vehicle 12 to be in communication with one or more local or remote networks (e.g., one or more networks at remote facility 80 or computers 78) via packet-switched data communication. This packet switched data communication may be carried out through use of a non-vehicle wireless access point or cellular system that is connected to a land network via a router or modem. When used for packet-switched data communication such as TCP/IP, the communications device 30 can be configured with a static Internet Protocol (IP) address or can be set up to automatically receive an assigned IP address from another device on the network such as a router or from a network address server.

Packet-switched data communications may also be carried out via use of a cellular network that may be accessible by the telematics unit 30. Communications device 30 may, via cellular chipset 34, communicate data over wireless carrier system 70. In such a scenario, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

One of the networked devices that can communicate with the telematics unit 30 is a mobile computing device 57, such as a smart phone, personal laptop computer, smart wearable device, or tablet computer having two-way communication capabilities, a netbook computer, or any suitable combinations thereof. The mobile computing device 57 can include computer processing capability and memory (not shown) and a transceiver capable of communicating with wireless carrier system 70. Examples of the mobile computing device 57 include the iPhone™ manufactured by Apple, Inc., and the Droid™ manufactured by Motorola, Inc. as well as others. Mobile device 57 may moreover be used inside or outside of vehicle 12, and may be coupled to the vehicle by wire or wirelessly. When using a SRWC protocol (e.g., Bluetooth/Bluetooth Low Energy or Wi-Fi), mobile computing device 57 and telematics unit 30 may pair/link one with another when within a wireless range (e.g., prior to experiencing a disconnection from the wireless network).

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the telematics unit 30 to provide a wide variety of services. For instance, in one embodiment, the processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the telematics unit 30 also includes a modem for communicating information over the communications bus 58.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 58 and an entertainment bus (not shown) and can provide AM, FM and satellite radio, CD, DVD, and other multimedia functionality. This functionality can be provided in conjunction with or independent of an infotainment module. Microphone 54 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, a video projector that projects images onto the windshield from the vehicle cabin ceiling, or some other display. Various other vehicle-user interfaces can also be utilized, as the interfaces of FIG. 1 are only an example of one particular implementation.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components that may be needed to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with a vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown) can be used for one or more purposes, such as for providing backend vehicle services to a plurality of vehicles (such as vehicle 12) and/or for providing other vehicle-related services. The computers 78 can be some of a number of computers accessible via a private or public network such as the Internet. Other such accessible computers 78 can be, for example: a service center computer where diagnostic information and other vehicle data can be uploaded from the vehicle; a client computer used by the vehicle owner or other subscriber for various purposes, such as accessing and/or receiving data communicated from the vehicle, as well as setting up and/or configuring subscriber preferences or controlling vehicle functions; or a vehicle telemetry data server that receives and stores data from a plurality of vehicles.

Vehicle backend services facility 80 is a remote facility, meaning that it is located at a physical location that is located remotely from the vehicle 12. The vehicle backend services facility 80 (or “remote facility 80” for short) may be designed to provide the vehicle electronics 20 with a number of different system back-end functions through use of one or more electronic servers 82 or live advisors. The vehicle backend services facility 80 includes vehicle backend services servers 82 and databases 84, which may be stored on a plurality of memory devices. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally stored instructions, such as software or firmware, which enable the servers 82 to provide a wide variety of services. For network communications (e.g., intra-network communications, inter-network communications including Internet connections), the servers can include one or more network interface cards (NICs) (including, for example, wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. One or more databases 84 at the remote facility 80 can store various information and can include a vehicle operation database that stores information regarding the operation of various vehicles (e.g., vehicle telemetry or sensor data).

### Method

The method or parts thereof can be implemented in a computer program product (e.g., a BCM 24, VKM 25, server 82, computers 78, telematics unit 30, etc.) embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

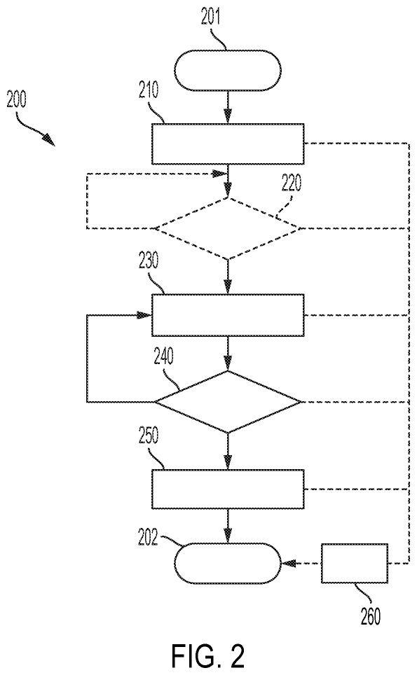

Turning now to FIG. 2, there is shown an embodiment of a method 200 to detect helpless occupants such as, for example, children and pets trapped within a vehicle interior. One or more aspects of the occupant detection method 200 may be completed through telematics unit 30 which may include one or more executable instructions incorporated into memory device 38 and carried out by electronic processing device 36. One or more ancillary aspects of method 200 may also be completed by BCM 24 and/or VKM 25, remote entity 80 (e.g., via server 82), or computers 78. Skilled artisans will moreover see that telematics unit 30, remote entity 80, computers 78, and mobile computing device 57 may be remotely located from each other.

Method 200 is supported by telematics unit 30 being configured to communicate with remote entity 80, computers 78, and mobile computing device 57. This configuration may be made by a vehicle manufacturer at or around the time of the telematics unit's assembly or after-market (e.g., via vehicle download using the afore-described communication system 10 or at a time of vehicle service, just to name a couple of examples). Method 200 is supported by telematics unit 30 and/or one or more VSMs 28 (e.g., VKM 25) being configured to store one or more reference RSSI values as well as one or more threshold RSSI values. This configuration may be made by a vehicle manufacturer at or around the time of the vehicle's assembly or after-market (e.g., via vehicle download to telematics unit 30 using the afore-described communication system 10 or at a time of vehicle service, just to name a couple of examples). Method 200 is further supported by preconfiguring remote entity 80, computers 78, and mobile computing device 57 to receive and store an emergency notification.

Method 200 begins at 201 in which the air conditioning operations of the vehicle's HVAC system are turned to an OFF state by BCM 24 (e.g., after the engine has been deactivated, the ignition is powered down, and other vehicle operations are shut off). Moreover, each one of the vehicle's windows 11 (including, but not limited to, the sun/moon roof window) and doors 13 are closed and the vehicle's interior cabin is substantially sealed (which may include the vehicle's trunk). It should be understood that method 200 can begin when all of these circumstances occur (i.e., when the engine is powered down after all doors and windows have been closed or when the engine has been previously powered down and all door and windows are subsequently closed).

In step 210, telematics unit 30, SRWC circuit 32, or one or more VSMs 28 (e.g., BCM 24, VKM 25, etc.) will activate a vehicle interior occupant detection process. For example, upon activation of this process, the SRWC circuit 32 and/or each of the BLE nodes 26 will be turned to an operational state. Moreover, the BLE nodes 26 will become ready to transmit and receive SRWC signals from the other BLE nodes 26, SRWC circuit 32, one or more VSMs 28 (e.g., BCM 24, VKM 25, etc.). A system timer (second time period) will also be established and begin counting down its established time, which will determine how long the occupant detection process will last before being deactivated. The system timer may, for example, establish that the occupant detection process will be operational for two (2) hours. It should be understood that the detection process can detect vehicle occupants within the trunk of vehicle 12 (regardless of whether the trunk is located at the vehicle's front end or back end).

In optional step 220, telematics unit 30, the SRWC circuit 32, or the one or more VSMs 28 will correspond with an internal vehicle thermometer to gauge the temperature within the vehicle cabin. Moreover, in this step, telematics unit 30/SRWC circuit 32/one or more VSMs 28 will determine whether the sensed temperature is within certain temperature parameters (i.e., whether the sensed temperature is either greater than a high temperature threshold or below a low temperature threshold). For example, it will be determined whether the sensed temperature is below 70 degrees Fahrenheit or above 63 degrees Fahrenheit (or some other temperatures deemed to be beyond the safety zone for small children and/or pets locked within vehicles). If it is determined that the interior temperature is above/below this zone of thresholds, method 200 will move to step 230. However, if it determined the sensed temperature is within the temperature zone, then method 200 will return to the beginning of this step and continue monitoring the temperature within the vehicle to ensure that the vehicle cabin is considered to be substantially safe (which may be by known standards). As is generally known, the vehicle cabin's thermometer may be a hardware component installed somewhere in the vehicle's cabin and may be part of the vehicle's HVAC system.

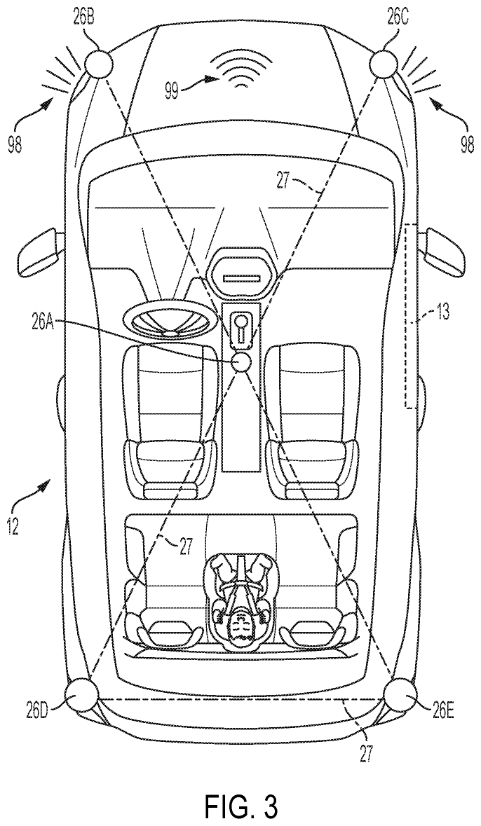

In step 230, telematics unit 30, the SRWC circuit 32, or the one or more VSMs 28 will monitor the transmitted BLE signal strength of one or more SRWC paths within vehicle cabin for the purposes of detecting an occupant. As follows, one or more of these system devices 28, 30, 32 will operate the BLE nodes 26 to transmit and receive SRWC signals from one of the other BLE nodes 26. With additional reference to FIG. 3, as shown, the BLE node 26A may be installed in the center of the vehicle's layout (e.g., the center stack) and the remaining BLE nodes 26B, 26C, 26D, and 26E may be installed at the vehicle's corners (e.g., in the engine cavity and trunk). Moreover, each of the BLE nodes 26A, 26B, 26C, 26D, and 26E can send and receive SRWC signals 27 with the other BLE nodes to create a Bluetooth mesh network throughout the vehicle 12. As such, one BLE node 26 can transmit SRWC signals 27 and another node can receive those signals as well as measure the received signal strength indication (RSSI) of that signal path 27. For example: BLE node 26B could transmit signal to BLE node 26C. BLE node 26C could then measure the RSSI of those signals from BLE node 26B. This process could continue with all the other BLE node combinations (26A, 26B, 26C, 26D, and 26E) transmitting and receiving SRWC signals 27 from the corresponding nodes (as well as measuring the RSSI from the corresponding nodes). Furthermore, after the RSSI has been measured by at least one BLE node 26, that RSSI information will be transmitted back to the telematics unit 30/SRWC circuit 32/one or more VSMs 28. It should be understood that the locations of the SRWC signal paths 27 shown in FIG. 3 are non-limiting and do not represent all variations of SRWC paths that can be implemented in the vehicle. It should also be understood that the BLE node locations represented in FIG. 3 are merely exemplary and other BLE node locations may be put into use.

In step 240, in one or more embodiments, multiple RSSI measurements from a BLE node 26 will be received by one or more of the system devices 28, 30, 32. As such, the current RSSI can be calculated as an average reading of these RSSI measurements over an established period of time, for example, two (2) seconds (first time period). As follows, this average RSSI=N# RSSI measurements (e.g., ten (10) measurements taken over the first-time period)/N# (e.g., ten (10)).

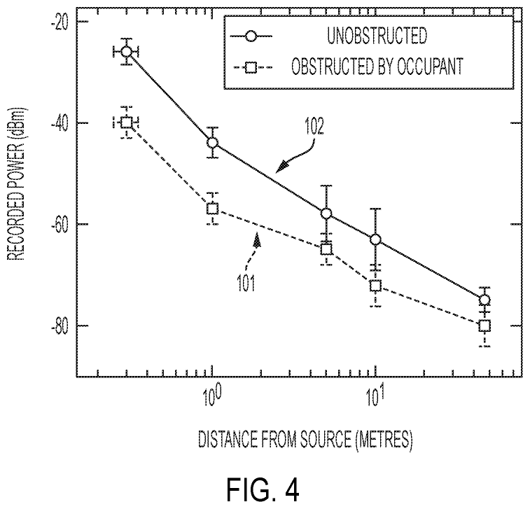

In this step, the telematics unit 30/SRWC circuit 24/one or more VSMs 28 will also compare the current RSSI measurement with a reference RSSI measurement, which has been previously stored in a corresponding memory device. This reference RSSI represents the vehicle interior when there are no occupants present (or any other living beings for that matter). For instance, as mentioned above, the reference RSSI can be measured by the BLE nodes 26 (or some other measuring devices) and stored in the system at the time of vehicle manufacture. Moreover, in this step, the system component(s) will compare the current RSSI and reference RSSI and determine whether there is a difference between the two measurements. With additional reference to FIG. 4, as can be seen, when a vehicle is occupied by a child or pet, the current RSSI measurement (the measurement line 101—titled, “obstructed by an occupant”) can be substantially lower than the reference RSSI measurement (the measurement line 102—titled, “unobstructed”). For example, when the BLE nodes 26 are one (1) meter apart, the measured current RSSI 101 can be approximately −55 dBm, while the measured reference RSSI 102 can be approximately −40 dBm. Thus, in this instance, there would be a difference of 15 dBm. In another example, when the BLE nodes 26 are ten (10) meters apart, the measured current RSSI 101 can be approximately −75 dBm, while the measured reference RSSI 102 can be approximately −65 dBm. Thus, in this instance, there would be a difference of 10 dBm.

In this step, moreover, the telematics unit 30/SRWC circuit 24/one or more VSMs 28 will determine whether there is a significant difference between the reference and current RSSI values 101, 102. To do this, it will be determined if this difference is greater than a threshold value, as discussed further below. If there is a significant difference between these RSSI values, method 200 will move to step 250; otherwise, method 200 will return to step 230 to go back to monitoring the BLE signal strength along one or more SRWC paths 27.

In step 250, the telematics unit 30/SRWC circuit 24/one or more VSMs 28 will activate at least one vehicle system. For example, the BCM 24 will at least partially open one or more of the power windows 11 on one or more vehicle doors 11. In this instance, in particular, these windows 11 may be opened two (2) or three (3) inches so as to let fresh air into and some of the heat out of the vehicle cabin. In an additional example, the BCM 24 will turn the air conditioning operations to an ON state so as to reduce the temperature within the vehicle's interior. In another example, looking at FIG. 3, the BCM 24 will activate the vehicle's horn system and light system to cause the horn and headlamps to make noise and light in an ordered sequence (i.e., as if a vehicle alarm was set off—in other words, the temporary horn and headlamp activations will alternate). This would attempt to get the attention of any pedestrians in proximity of vehicle 12, in hopes that one or more of these pedestrians will come to the rescue of the trapped child or pet. In yet another example, telematics system 30 will send an emergency notification to either the remote entity 80 and/or mobile computing device 57 (which could be relayed through server 82). As such, when sent to the mobile computing device 57, this emergency notification can be configured to get the attention of the vehicle owner so that they can return to their car and rescue the occupant child or pet. An exemplary notification may state (via one or more GUIs) “WARNING: THERE MAY BE A CHILD OR PET LEFT BEHIND IN YOUR VEHICLE”. As such, when sent to the remote entity 80, this emergency notification can be configured to be sent to a live advisor and can state “THERE MAY BE A CHILD OR PET TRAPPED IN THE VEHICLE ASSOCIATED WITH THIS ACCOUNT” and can be a text message displayed on a computer at the advisor's desk or it may be an automated call made to the live advisor and may contain other vehicle information. This will allow the live advisor to remotely open one or more of the vehicle's windows as well as notify an emergency services provider (e.g., the police) located in the vicinity of the vehicle's location. This emergency notification can also be configured to be sent to server 82 so that the server 82 will automatically open the vehicle windows and contact an emergency services provider. After step 250, method 200 will move to completion 202.

At any point during method 200, in optional step 260, when the system timer expires (e.g., after two hours) method 200 will automatically move to completion 202. As follows, after such a prolonged period of time, it is assumed that no occupant actually exists in the vehicle interior. In addition (or alternatively), when the air conditioning operations of the HVAC system are turned to the ON state, method 200 will automatically move to completion 202. In addition (or alternatively), when one or more of the vehicle doors 13 are opened up (e.g., to allow the vehicle owner to enter into the interior of vehicle 12), method 200 will automatically move to completion 202. In this step, the one or more vehicle systems will also be deactivated. For instance, any notifications being sent out by telematics unit 30 will be discontinued. After optional step 260, method 200 will move to completion 202.

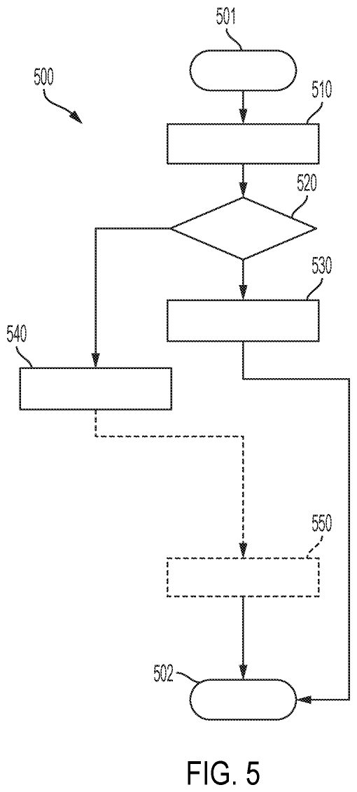

The flowchart of FIG. 5 depicts a more detailed version of one or more embodiments of step 240 of FIG. 2. In step 510, as discussed above, the current RSSI will be calculated. This may be by calculating the average of multiple received RSSI readings from a BLE node 26. In step 520, the current RSSI will be compared to the reference RSSI. For example, the comparison can be the difference between the current RSSI and reference RSSI (i.e., the reference RSSI value subtracted from the current RSSI value). Furthermore, in this step, the value of the difference between these two RSSI values (i.e., the difference value) will be compared to a threshold value (e.g., 2 dBm) and it will be determined whether the difference value (e.g., 10 dBm) is greater than the threshold value (e.g., 2 dBm). When the difference value is determined to be greater than the threshold value, method 500 will move to step 530; otherwise, method 500 will move to step 540.

In step 530, an occupant will be considered to be detected. For example, a helpless child or pet such as a dog or cat are trapped within the vehicle's interior, as discussed above. After step 530, method 500 will move to 502 where it will move along in the steps of the broader the methodology, as discussed with regard to method 200 of FIG. 2 (e.g., activation of one or more vehicle systems). In step 540, the vehicle is determined to be free of vehicle occupants (for at least that specific RSSI determination). As such, method 500 will move to optional step 550. In optional step 550, it will be determined whether the difference value is less than a second threshold value (e.g., 14 dBm). Moreover, when the difference value is less than this second threshold value, the current RSSI value can be stored as an updated version of the reference RSSI in one or more of the memory devices of vehicle 12. Updating the reference RSSI in this manner will ensure better accuracy in future comparisons between the current and reference RSSI values. After step 530, method 500 will move to 502 where it will move along in the steps of the broader the methodology, as discussed with regard to method 200 of FIG. 2 (e.g., returning to step 230 in method 200).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method to detect occupants within a vehicle interior, the method comprising:
calculating a current received signal strength indication (RSSI) within a vehicle interior;
comparing the current RSSI to a reference RSSI; and
based on comparing the current RSSI and reference RSSI, activating one or more vehicle systems.

2. The method of claim 1, further comprising:
wherein comparing the current RSSI and reference RSSI is the difference between the current RSSI and the reference RSSI;
determining whether the difference between the current RSSI and reference RSSI is greater than a threshold value; and
wherein activating the one or more vehicle systems occurs only after the difference between the current RSSI and the reference RSSI is determined to be greater than the threshold value.

3. The method of claim 2, wherein:
wherein the difference between the current RSSI and the reference RSSI is determined a plurality of times until an expiration of a second-time period or when the difference between the current RSSI and the reference RSSI is determined to be greater than a threshold value; and
in response to air conditioning operations being turned to an ON state or one or more vehicle doors being opened or the expiration of the second-time period, deactivating the one or more vehicle systems and/or the method will move to completion.

4. The method of claim 1, further comprising:
sensing a temperature within the vehicle interior as a vehicle temperature;
determining whether the vehicle temperature is greater than a threshold temperature; and
wherein calculating the current RSSI occurs only after the vehicle temperature is determined to be greater than a threshold temperature.

5. The method of claim 1, wherein calculating the current RSSI occurs only after air conditioning operations are turned to an OFF state and all vehicle doors are closed.

6. The method of claim 1, wherein the current RSSI comprises calculating a plurality of RSSI measurements over a first-time period and calculating an average RSSI measurement from the plurality of RSSI measurements.

7. The method of claim 1, wherein activating the one or more vehicle systems comprises at least partially opening one or more vehicle windows.

8. The method of claim 1, wherein activating the one or more vehicle systems comprises activating a horn system and a light system in an ordered sequence.

9. A system to detect occupants within a vehicle interior, the system comprising:
a memory configured to comprise one or more executable instructions and a processor configured to execute the executable instructions, wherein the executable instructions enable the processor to:
calculate a current received signal strength indication (RSSI) within a vehicle interior;
compare the current RSSI to a reference RSSI; and
based on the comparison of the current RSSI and reference RSSI, activate one or more vehicle systems.

10. The system of claim 9, further comprising:
wherein the comparison of the current RSSI and reference RSSI is the difference between the current RSSI and the reference RSSI;
determine whether the difference between the current RSSI and reference RSSI is greater than a threshold value; and
wherein the one or more vehicle systems occurs are activated after the difference between the current RSSI and the reference RSSI is determined to be greater than the threshold value.

11. The system of claim 10, further comprising:
wherein the difference between the current RSSI and the reference RSSI is determined a plurality of times until an expiration of a second-time period or when the difference between the current RSSI and the reference RSSI is determined to be greater than a threshold value; and
in response to air conditioning operations being turned to an ON state or one or more vehicle doors being opened or the expiration of the second-time period, deactivate the one or more vehicle systems and/or the processor will cause the system to move to completion.

12. The system of claim 9, further comprising:
calculate a temperature within the vehicle interior as a vehicle temperature;
determine whether the vehicle temperature is greater than a threshold temperature; and
wherein the calculation of the current RSSI occurs only after the vehicle temperature is determined to be greater than a threshold temperature.

13. The system of claim 9, wherein the calculation of the current RSSI occurs only after air conditioning operations are turned to an OFF state and all vehicle doors are closed.

14. The system of claim 9, wherein the current RSSI comprises a calculation of a plurality of RSSI measurements over a first-time period and a calculation of an average RSSI measurement from the plurality of RSSI measurements.

15. The system of claim 9, wherein activation of the one or more vehicle systems comprises at least partially opening one or more vehicle windows.

16. The system of claim 9, wherein activation of the one or more vehicle systems comprises activation of a horn system and a light system in an ordered sequence.

17. A non-transitory and machine-readable medium having stored thereon executable instructions adapted to detect occupants within a vehicle interior, which when provided to a processor and executed thereby, causes the processor to:
calculate a current received signal strength indication (RSSI) within a vehicle interior only after air conditioning operations are turned to an OFF state and all vehicle doors are closed;
compare the current RSSI to a reference RSSI; and
based on the comparison of the current RSSI and reference RSSI, at least partially open one or more vehicle windows, or activate of a horn system and a light system in an ordered sequence, or send an emergency notification to a remote entity or mobile computing device, or some combination thereof.

18. The non-transitory and machine-readable memory of claim 17, which further causes the processor to:
wherein the comparison of the current RSSI and reference RSSI is the difference between the current RSSI and the reference RSSI;
determine whether the difference between the current RSSI and reference RSSI is greater than a threshold value; and
wherein the one or more vehicle systems occurs are activated after the difference between the current RSSI and the reference RSSI is determined to be greater than the threshold value.

19. The non-transitory and machine-readable memory of claim 17, which further causes the processor to:
calculate a temperature within the vehicle interior as a vehicle temperature;
determine whether the vehicle temperature is greater than a threshold temperature; and
wherein the calculation of the current RSSI occurs only after the vehicle temperature is determined to be greater than a threshold temperature.

20. The non-transitory and machine-readable memory of claim 17, wherein the current RSSI comprises a calculation of a plurality of RSSI measurements over a first-time period and a calculation of an average RSSI measurement from the plurality of RSSI measurements.
